(19) United States
(12) Patent Application Publication
(10) Pub. No.: US 2011/0207110 A1
(43) Pub. Date: Aug. 25, 2011

(54) APPARATUS AND METHOD FOR DETERMINING TRAINING LOAD

(75) Inventor: Jukka HUOVINEN, Jyvaskyla (FI)

(73) Assignee: NEWWELL OY, KAJAANI (FI)

(21) Appl. No.: 12/711,531

(22) Filed: Feb. 24, 2010

(51) Int. Cl. G09B 25/00

(52) U.S. Cl. 434/365

(57) ABSTRACT

An apparatus and a method are provided. The provided solution comprises: receiving, by an interface, the duration of at least one training session scheduled for a given day and a training event type of the session; reading from a database information on an average training load of at least one training event; determining, by a controller, a training load for a given training session on the basis of the duration of the session, and an average training load of the event type of the training session; determining by a controller, a daily training load on the basis of training sessions scheduled for the given day; and categorizing by a controller, the daily training load into a category of a predetermined number of categories.

### FIELD

Embodiments of the invention relate generally to determining a training load.

### BACKGROUND

It is important to plan training sessions carefully on order to keep the level of training suitable for a trainee. Too heavy training increases the risk of injuries and excess fatigue. On the other hand, too light training does not produce desired results.

The above problems are especially consequential when the training of a large group of individuals is to be planned. The initial fitness level of the individuals may be radically different. It is a difficult task to plan a suitable training program for such a group. This also applies to the training of recruits or soldiers in a military environment, during a military basic training season in particular.

It has been noted that the initial fitness level of recruits varies considerably at the beginning of a military basic training season. Overall, the physical performance of the recruits has declined over the years. Too heavy training increases the probability of injuries and drop outs of the recruits.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to an aspect of the present invention, there is provided an apparatus comprising: a processor, a memory including computer program instructions, the memory and the computer program instructions being configured, together with the processor, to cause the apparatus to: receive, as an input, a duration of at least one training session scheduled for a given day, and a training event type of the session, read from a database information on an average training load of at least one training event, determine a training load for a given training session on the basis of the duration of the session and an average training load of the event type of the training session; determine a daily training load on the basis of the training sessions scheduled for a given day; and categorize the daily training load into a category of a predetermined number of categories.

The apparatus may be configured to determine a weekly training load on the basis of the daily training loads and to categorize the weekly training load into a category of a predetermined number of categories.

The apparatus may be configured to group the predetermined number of categories into three groups corresponding to an easy, moderate or heavy training load; and display each category group with a different color.

According to another aspect of the present invention, there is provided a method comprising: receiving, by an interface, a duration of at least one training session scheduled for a given day, and a training event type of the session; reading from a database information on average training load of at least one training event; determining, by a controller, a training load for a given training session on the basis of the duration of the session and an average training load of the event type of the training session; determining, by a controller, a daily training load on the basis of training sessions scheduled for a given day; and categorizing, by a controller, the daily training load into a category of a predetermined number of categories.

According to another aspect of the present invention, there is provided an article of manufacture, comprising a computer readable medium and embodying program instructions thereon executable by a computer operably coupled to a memory, which, when executed by the computer, performs steps of receiving a duration of at least one training session scheduled for a given day, and a training event type of the session; reading information on an average training load of at least one training event; determining, by a controller, a training load for a given training session on the basis of the duration of the session, and an average training load of the event type of the training session; determining a daily training load on the basis of training sessions scheduled for a given day; and categorizing the daily training load into a category of a predetermined number of categories.

According to yet another aspect of the present invention, there is provided an apparatus comprising means for receiving a duration of at least one training session scheduled for a given day, and a training event type of the session; means for reading information on an average training load of at least one training event; means for determining the training load for a given training session on the basis of the duration of the session, and an average training load of the event type of the training session; means for determining a daily training load on the basis of the training sessions scheduled for a given day; and means for categorizing the daily training load into a category of a predetermined number of categories.

Although the various aspects, embodiments and features of the invention are recited independently, it should be appreciated that all combinations of the various aspects, embodiments and features of the invention are possible and within the scope of the present invention as claimed.

### LIST OF DRAWINGS

Embodiments of the present invention are described below, by way of example only, with reference to the accompanying drawings, in which

FIG. 1 illustrates a simplified example of an apparatus of an embodiment of the invention;

FIG. 2 illustrates an example of an embodiment.

FIGS. 3 to 5 are flowcharts illustrating some embodiments of the invention.

### DESCRIPTION OF EMBODIMENTS

Exemplary embodiments of the present invention will now be de-scribed in closer detail hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

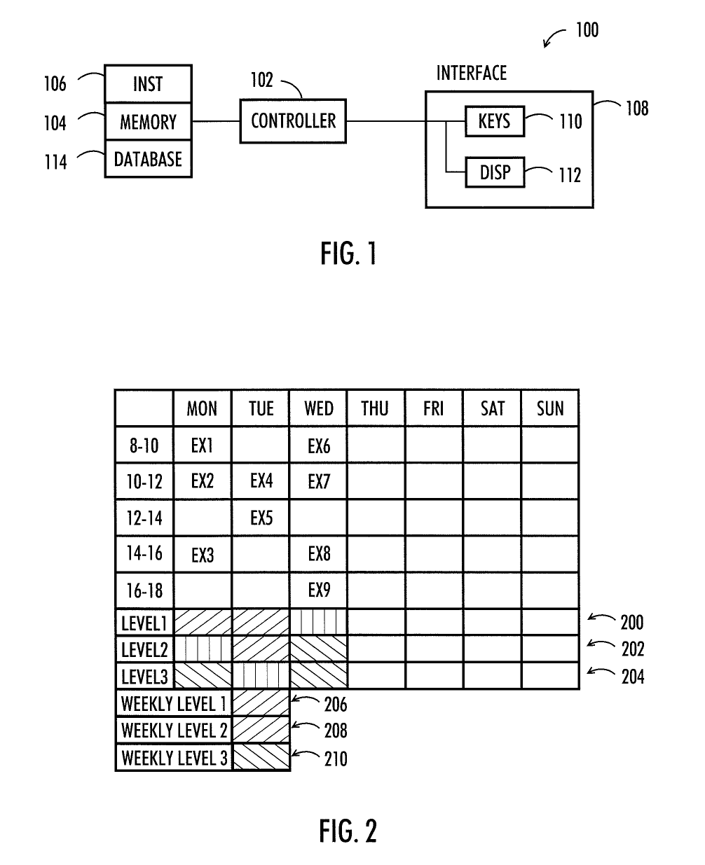

FIG. 1 is a simplified example of an apparatus of an embodiment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures.

The apparatus 100 comprises a processor 102 and a memory 104 including computer program instructions 106. The memory 104 and the computer program instructions 106 are configured, together with the processor 102, to cause the apparatus 100 to receive, as an input a duration of at least one training session scheduled for a given day, and a training event type of the session. In an embodiment, the apparatus comprises an interface 108 with which data input/output may be performed. The interface 108 may comprise a keyboard 110 and a display 112 or interfaces to external apparatuses performing corresponding actions. In addition, the interface 108 may comprise an interface to an external apparatus from which required input may be received.

The memory 104 may be configured to store a database 114 comprising information on an average training load of at least one training event.

The memory 104 and the computer program instructions 106 are configured, together with the processor 102, to cause the apparatus 100 to read from the database information on average training load of at least one training event, determine the training load for a given training session on the basis of the duration of the session and the average training load of the event type of the training session; determine a daily training load on the basis of the training sessions scheduled for a given day; and categorize the daily training load into a category of a predetermined number of categories.

The embodiments of the invention are not, however, restricted to the apparatus given above as an example but a person skilled in the art may apply the solution to other systems provided with the necessary properties.

Let us study an embodiment of the invention by using the training of soldiers in a military environment, as a non-limiting example. Thus, the task is to plan physical exercises for a platoon or another corresponding group of individuals.

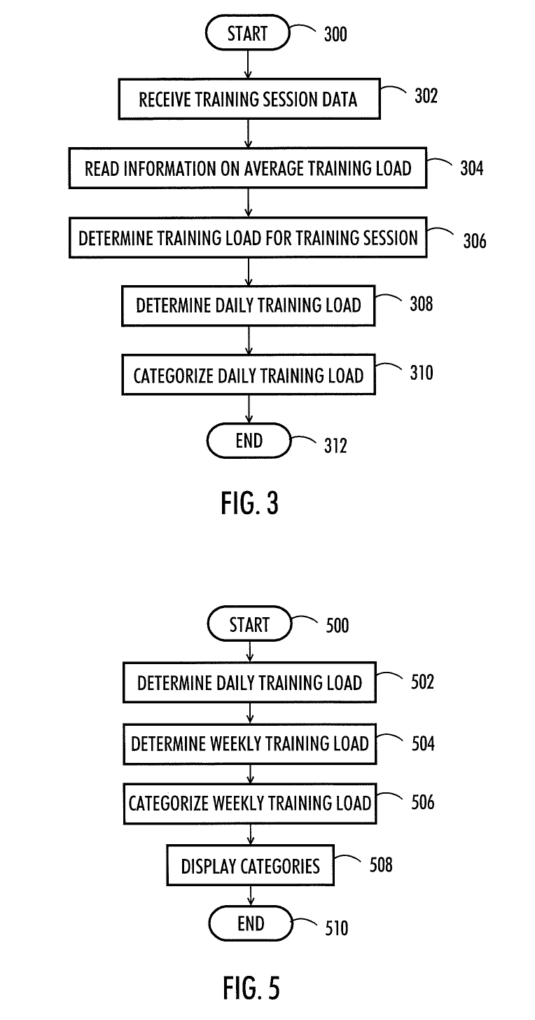

FIG. 2 illustrates an example of how the durations of training sessions scheduled for a given day and the training event types of the sessions may be entered. FIG. 2 shows a weekly schedule with which training events may be planned. The example of FIG. 2 shows possible exercise times in the leftmost column and the days of the week as seven adjacent columns. It should be noted that the exercise times and all other information presented in FIG. 2 are for illustrative purposes only. The schedule of FIG. 2 may be shown to a user on the display 112, for example.

In this example, the planned exercises have been entered into the schedule for Monday, Tuesday and Wednesday. For Monday, there are exercises at 8 a.m. to 10 a.m., 10 a.m. to noon and 2 p.m. to 4 p.m. For Tuesday, there are exercises at 10 a.m. to noon and noon to 2 p.m. For Wednesday, there are exercises at 8 a.m. to 10 a.m., 10 a.m. to 12 a.m., 2 p.m. to 4 p.m. and 4 p.m. to 6 p.m.

The schedule of FIG. 2 shows the exercises as EX1 to EX9. In practice, the training type of an exercise may have a predetermined code. For example, a march of a given type may have a predetermined code, a march of another type may have another predetermined code, a particular shooting exercise may have its own predetermined code. The purpose of the predetermined codes is to distinguish each exercise from one another. Thus, exercises of different physical loads may be separated from each other.

The memory 104 may be configured to store a database 114 comprising information on an average training load of different types of exercises and training events. The database may have been gathered using field tests. For example, a large number of trainees have performed different types of exercises. After an exercise, the heart rate of each trainee has been measured. On the basis of the heart rate and prior measurements from the trainee, the training load of an exercise may be estimated. There are several known methods for estimating the training load of an exercise on the basis of the heart rate of a participant and the duration of the event. One known method of calculating a training load is to use the formula for training impulse (TRIMP) where

TRIMP=A·B·C,

where A is the exercise time, B is proportionality of heart rate [(average training heart rate−resting heart rate)/(maximum heart rate−resting heart rate)], and C is 0.62e^{192B} for men and 0.84e^{167B} for women. This formula gives the training impulse as a multiplication of the training volume with training intensity and it was proposed by Dr. Eric Bannister in 1999 in an article Banister, E. W. (1991), Modeling elite athletic performance, Green H J, McDougal J D, Wenger H (eds) Physiological testing of elite athletes. Human Kinetics, Champaign, Ill., 403-424.

Thus, after measuring the heart rate of a large number of soldiers after a known exercise it is possible to calculate an average training load in proportion to the length of the exercise and store the obtained average training load in the database.

In an embodiment, the average training load may be calculated using other measurements. For example, activity sensors may be utilized to measure the activity of individuals during training sessions. The activity is related to the training load of the individuals. Activity sensors may be realized with accelerometers, for example.

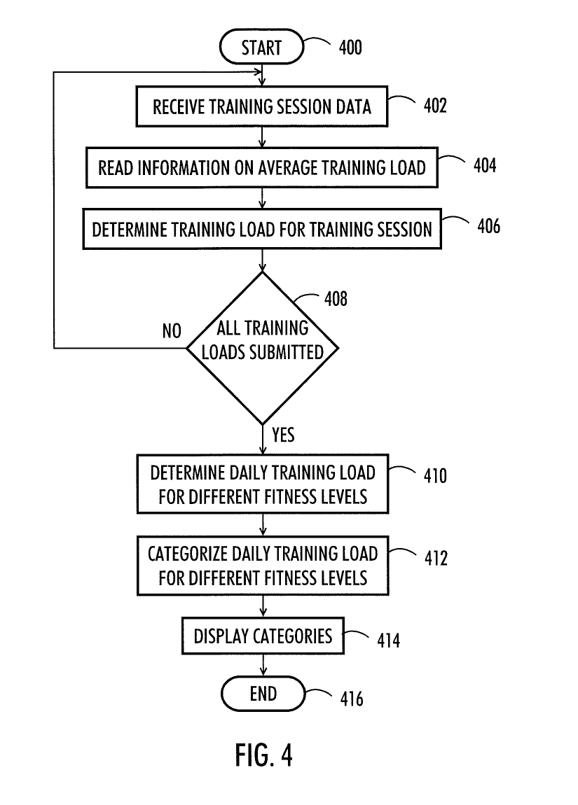

FIG. 3 is a flowchart illustrating an embodiment of the invention.

The procedure starts in step 300.

In step 302, training session data is received. A duration of at least one training session scheduled for a given day and a training event type of the session are received as described in connection with FIG. 2, for example. The data may be received also in different format with a different user interface, as is well known to one skilled in the art.

In step 304, information on average training load of the at least one training event is read. In an embodiment, the information is read from a database configured to store such information.

In step 306, the training load for a given training session is determined on the basis of the duration of the session and an average training load of the event type of the training session.

In step 308, a daily training load is determined on the basis of the training sessions scheduled for a given day. The training loads of the given day may be summed to obtain a cumulative training load for the given day.

In step 310, the daily training load is categorized into a category of a predetermined number of categories. For example, the daily training load may be categorized into five different categories 1 to 6 on the basis of how hard the training is. A very low daily training load might be categorized into category 1, a moderate daily training load might be categorized into category 3 or 4, and a very heavy daily training load into category 6.

In step 312, the procedure ends.

The category of the daily training load gives an instructor of the trainees a clear picture of how hard each training day has been for the trainees. This helps in adjusting the daily exercises to be of a suitable physical load.

FIG. 4 is a flowchart illustrating another embodiment of the invention.

The procedure starts in step 400.

In step 402, training session data is received. A duration of a training session scheduled for a given day and a training event type of the session are received as described in connection with FIG. 2, for example. The data may be received also in different format with a different user interface, as is well known to one skilled in the art.

In step 404, information on an average training load of the training event is read. In an embodiment, the information is read from a database configured to store such information.

In step 406, a training load for the training session is determined on the basis of the duration of the session and the average training load of the event type of the training session. The training load may be calculated for more than one fitness level. The database may store average training loads for more than one fitness level. If the fitness level of a trainee is high, a given exercise may not be especially hard for the trainee. On the other hand, if the fitness level of another trainee is low, the training load of the same exercise may be very heavy for that trainee. The information stored in the database may take this into account by storing different average training loads for different fitness levels.

In step 408, it is checked whether all training loads have been submitted. If not, the process continues in step 402. If all training loads have been submitted, the process continues in step 410.

In step 410, a daily training load is determined on the basis of the training sessions scheduled for a given day. The training loads of the given day may be summed to obtain a cumulative training load for the given day. The daily training load may be calculated separately for different fitness levels.

In step 412, the daily training loads determined in the previous step are categorized into a category of a predetermined number of categories. The daily training loads for different fitness levels may be categorized into different categories. Thus, using the six categories of step 310 above as an example, the daily training load of a high fitness level may be categorized into category 3 while the daily training load of a low fitness level may be categorized into category 6 even though the actual exercises for the day may have been the same.

In step 414, the categories are displayed. There are various alternatives in displaying the categories. In an embodiment, the category of the daily training load is displayed as a number, for example 1 to 6. In another embodiment, different categories are presented with different colors. For example, if three categories, a light load, a moderate load and a heavy load, are given, the colors might be green, yellow and red, respectively.

In an embodiment, the categories are grouped into three groups corresponding to a light, moderate or heavy training load. Thus, using the six categories of step 310 above as an example, categories 1 and 2 might be grouped into a first group corresponding to a light training load. Categories 3 and 4 might be grouped into a second group corresponding to a moderate training load, and categories 5 and 6 might be grouped into a third group corresponding to a heavy training load.

In an embodiment, each category group is displayed with a different color, wherein the light, moderate and heavy category groups are displayed with the colors of green, yellow and red colors, respectively. In addition, a category may be displayed with both text or a number and a color or with any graphical presentation.

In FIG. 2, an example is illustrated where each category group is denoted with a different hatch. Below a space reserved for training session reservations three rows 200, 202, 204 are shown. These rows display the daily training load for three different fitness levels, Level 1, Level 2, and Level 3.

For example, on Monday the training load for fitness level 1 is illustrated with a right-leaning hatch, which may denote a heavy training load. The training load for fitness level 2 is illustrated with a vertical hatch, which may denote a moderate training load. The training load for fitness level 3 is illustrated with a left-leaning hatch, which may denote a light training load.

In step 416, the procedure ends.

FIG. 5 is a flowchart illustrating another embodiment of the invention.

The procedure starts in step 500.

In step 502, a daily training load is determined. The load may be determined as described in connection with FIGS. 3 and 4. The training load may be determined for several days of a week. In addition, the daily training loads may be categorized as described in connection with FIGS. 3 and 4. FIG. 2 illustrates an example where the training loads are determined for Monday, Tuesday and Wednesday. Typically, however, the training loads are determined for the whole week at a time.

In step 504, a weekly training load is determined. The weekly training load is determined on the basis of the daily training loads of a particular week. The weekly training load may be calculated separately for different fitness levels. The daily training loads of a given week may be summed to obtain a cumulative training load for the given week.

In step 506, the weekly training load determined in the previous step is categorized into a category of a predetermined number of categories. The weekly training loads for different fitness levels may be categorized into different categories. The categorizing step may be performed as explained above in connection with step 412, for example.

In step 508, the categories are displayed. Different categories may be denoted as explained above in connection with step 414.

In step 510, the procedure ends.

In FIG. 2, an example is illustrated where each category group of a weekly training load is denoted with a different hatch. Below a space reserved for daily training loads includes three rows 206, 208, 210. These rows show the weekly training load for three different fitness levels, Level 1, Level 2, and Level 3.

For example, on Monday the weekly training load for fitness levels 1 and 2 are illustrated with a right-leaning hatch, which may denote a heavy training load. The weekly training load for fitness level 3 is illustrated with a vertical hatch, which may denote a medium training load. Again, any graphical presentation may be used to denote the different training loads. For example the colors of green, yellow, and red may be used to denote light, moderate and heavy training load, respectively.

Above, the inventive concept is applied to planning training exercises of soldiers or other individuals. The same inventive concept may be applied not only in connection of physical training exercises but also in connection with other types of activities. For example, the inventive concept may be utilized in planning of physical activities of elderly or handicapped people. The physical activities need not be physical training sessions but they may be physical actions of any type, such as a walk or a visit to a shopping mall, for example.

It should be understood that the apparatus is depicted herein as an example illustrating some embodiments. It is apparent to a person skilled in the art that the apparatus may also comprise other functions and/or structures. Although the apparatus has been depicted as one entity, different modules and memory may be implemented in one or more physical or logical entities.

The apparatus may be any server, computer, device or corresponding component providing the required functionality.

The apparatus of FIG. 1 may be implemented as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

The apparatus may be implemented using at least one chipset or integrated circuit such as ASICs (application-specific integrated circuit) and suitable programming.

Embodiments of the invention may be implemented as computer software executable by a processor, or as a combination of software and hardware.

An embodiment provides a computer program embodied on a distribution medium, comprising program instructions which, when loaded into an electronic apparatus, perform the actions described in connection with FIGS. 3 to 4.

The computer program may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital computer or it may be distributed amongst a number of computers.

The steps and the related functions described above in FIGS. 3 to 5 are in no absolute chronological order, and some of the steps may be performed simultaneously or in an order differing from the given one. Other functions can also be executed between the steps or within the steps and other signaling messages sent between the illustrated messages. Some of the steps or part of the steps can also be left out or replaced by a corresponding step or part of the step.

It will be obvious to a person skilled in the art that, as technology advances, the inventive concept can be implemented in various ways. The invention and its embodiments are not limited to the examples described above but may vary within the scope of the claims.

1. An apparatus comprising
a processor,
a memory including computer program instructions,
the memory and the computer program instructions being configured, together with the processor, to cause the apparatus to:
receive, as an input, a duration of at least one training session scheduled for a given day, and a training event type of the session,
read from a database information on an average training load of at least one training event,
determine a training load for a given training session on the basis of the duration of the session and an average training load of the event type of the training session;
determine a daily training load on the basis of the training sessions scheduled for a given day; and
categorize the daily training load into a category of a predetermined number of categories.

2. The apparatus of claim 1, wherein the memory and the computer program instructions are further configured, together with the processor, to cause the apparatus to:
determine a weekly training load on the basis of the daily training loads and to categorize the weekly training load into a category of a predetermined number of categories.

3. The apparatus of claim 1, wherein the predetermined number of categories is grouped into three groups corresponding to a light, moderate or heavy training load.

4. The apparatus of claim 1, wherein the memory and the computer program instructions are further configured, together with the processor, to cause the apparatus to display the category of the daily training load.

5. The apparatus of claim 3, wherein the memory and the computer program instructions are further configured, together with the processor, to cause the apparatus to display each category group with a different graphical presentation.

6. The apparatus of claim 3, wherein the memory and the computer program instructions are further configured, together with the processor, to cause the apparatus to display each category group with a different color, wherein the light, moderate and heavy category groups are displayed with the colors of green, yellow, and red.

7. The apparatus of claim 1, wherein the memory and the computer program instructions are further configured, together with the processor, to cause the apparatus to: store a database comprising information on an average training load of at least one training event for two or more fitness levels, determine a training load for a given training session for each fitness level, and display the category of the at least one training session of at least one fitness level.

8. A method comprising:
receiving, by an interface, a duration of at least one training session scheduled for a given day, and a training event type of the session;
reading from a database information on average training load of at least one training event;
determining, by a controller, a training load for a given training session on the basis of the duration of the session and an average training load of the event type of the training session;
determining, by a controller, a daily training load on the basis of training sessions scheduled for a given day; and
categorizing, by a controller, the daily training load into a category of a predetermined number of categories.

9. The method of claim 8, further comprising:
determining a weekly training load on the basis of the daily training loads, and
categorizing the weekly training load into a category of a predetermined number of categories.

10. The method of claim 8, further comprising:
grouping the predetermined number of categories into three groups corresponding to a light, moderate or heavy training load; and
displaying each category group with a different graphical presentation.

11. The method of claim 8, further comprising:
grouping the predetermined number of categories into three groups corresponding to a light, moderate or heavy training load; and
displaying each category group with a different color, wherein the light, moderate and heavy category groups are displayed with the colors of green, yellow, and red colors.

12. The method of claim 8, further comprising:
reading from a database information on an average training load of at least one training event for two or more fitness levels;
determining a training load for a given training session for each fitness level; and
displaying the category of the at least one training session of at least one fitness level.

13. An article of manufacture, comprising a computer readable medium and embodying program instructions thereon executable by a computer operably coupled to a memory, which, when executed by the computer, performs steps of receiving a duration of at least one training session scheduled for a given day, and a training event type of the session; reading information on an average training load of at least one training event; determining, by a controller, a training load for a given training session on the basis of the duration of the session, and an average training load of the event type of the training session; determining a daily training load on the basis of training sessions scheduled for a given day; and categorizing the daily training load into a category of a predetermined number of categories.

14. An apparatus comprising:
means for receiving a duration of at least one training session scheduled for a given day, and a training event type of the session;
means for reading information on an average training load of at least one training event;
means for determining the training load for a given training session on the basis of the duration of the session, and an average training load of the event type of the training session;
means for determining a daily training load on the basis of the training sessions scheduled for a given day; and
means for categorizing the daily training load into a category of a predetermined number of categories.
